(19) United States
(12) Patent Application Publication
(10) Pub. No.: US 2025/0053029 A1
(43) Pub. Date: Feb. 13, 2025

(54) TINTED AND/OR SHADED LENS AND PROCESS FOR TINTING A TINTED AND/OR SHADED LENS

(71) Applicant: LUXOTTICA S.R.L., Agordo (BL) (IT)

(72) Inventors: Marco MARRAS, Meana Sardo (NU) (IT); Andrea GALLINA, Chieri (TO) (IT)

(21) Appl. No.: 18/719,954

(22) PCT Filed: Dec. 19, 2022
(86) PCT No.: PCT/IB2022/062467

§ 371 Date: Jun. 14, 2024

(30) Foreign Application Priority Data
Dec. 20, 2021 (IT) 102021000031823

(51) Int. Cl. G02C 7/10

(52) U.S. Cl. CPC G02C 7/10

(57) ABSTRACT

A lens tinted and/or shaded according to a particular and predefined shape having at least first and second colour zones and/or a third shaded zone according to a gradient of transition from the first to the second colours, the second colour zone and/or third shaded zone according to a gradient obtained by subjecting a colour lens to a process having the following steps:
positioning lenses on at least one frame, arranging the frame above a colouring tank or bath, the frame being vertically movable along first and second vertical axes z1, z2, respectively, the z1 stroke being greater than that of z2, the frame being rotatable about an axis of rotation, perpendicular to axes z1 and z2, and parallel to the free surface of the bath;
the shape on the lens obtained by a combination of movement according to axis z1, axis z2, and/or rotary axis or rotation direction.

### CROSS-REFERENCE TO RELATED APPLICATIONS

This application is a 35 U.S.C. § 371 National Stage patent application of PCT/IB2022/062467, filed on 19 Dec. 2022, which claims the benefit of Italian patent application 102021000031823, filed on 20-12-2021, the disclosures of which are incorporated herein by reference in their entirety.

### TECHNICAL FIELD

The present disclosure relates to a tinted and/or shaded lens.

The disclosure also relates to a process for obtaining a tinted and/or shaded lens.

In even more detail, the disclosure relates to a lens of the said type in which tinting and/or shading can take place substantially according to any free shape, sometimes even having convex curved sections.

### BACKGROUND

Tinted and shaded lenses for eyeglasses have been produced and marketed for decades.

In particular, they are obtained through an immersion tinting process, whereby the dyes are dispersed in a tank containing water and auxiliary chemicals.

In this process, a tinting machine has been successfully used for years to obtain these tinted and shaded lenses, as well as a washing line and then a drying line, for cleaning the surface of the lens and fixing the colour, respectively.

The known process involves a step of vertical immersion of the lenses in a dye bath and/or a vertical oscillation movement to obtain a shading zone.

Conventionally, a rotational movement of the lens is known in order to obtain a circular tint or shade.

However, by means of the known process and machines, lenses cannot be obtained with tinting and/or shading substantially according to any predetermined shape, whether closed or open.

### SUMMARY

In light of the above, the Applicant proposes a technology to obtain a tinted and/or shaded lens, in which the shape of the tinting and/or shading can be basically any type, open or closed and possibly also with convex curved sections.

Throughout this description, the shading shape according to the patent is that which comprises the centre of the lens and is therefore convex.

These and other results are obtained, according to the present disclosure, by proposing a tinted and/or shaded lens, which can be obtained by a process whereby a pre-tinted or transparent lens is immersed in a bath comprising at least one solvent and at least one dye, combining the movement immersion of the lens predominantly downwards with a rotational movement and possibly also with a further vertical oscillation movement.

The tinting of each individual point of the lens comes from the superposition of several layers of colour over time. In other words, the colour change is a function of the immersion time of the individual point of the lens. The layers of colour follow a particular and defined shape. This concept is applicable to both spectacle lenses and masks, such as ski masks.

### BRIEF DESCRIPTION OF THE DRAWINGS

The present disclosure will be described below according to its preferred embodiments, provided by way of non-limiting example, with particular reference to FIGS. 1-5 of the accompanying drawings, wherein:

FIG. 1 shows an illustrative diagram of the device adapted for the lens tinting process;

FIGS. 2A-2E show five embodiments of the lens according to the present disclosure;

FIGS. 3A-3C show graphs representing the change in transmittance from A to B;

FIGS. 4A and 4D show a device for obtaining lenses according to the disclosure, in four distinct processing steps; and

FIG. 5 shows an example of a lens obtained with the device according to FIGS. 4A-4D.

### DETAILED DESCRIPTION OF THE DRAWINGS

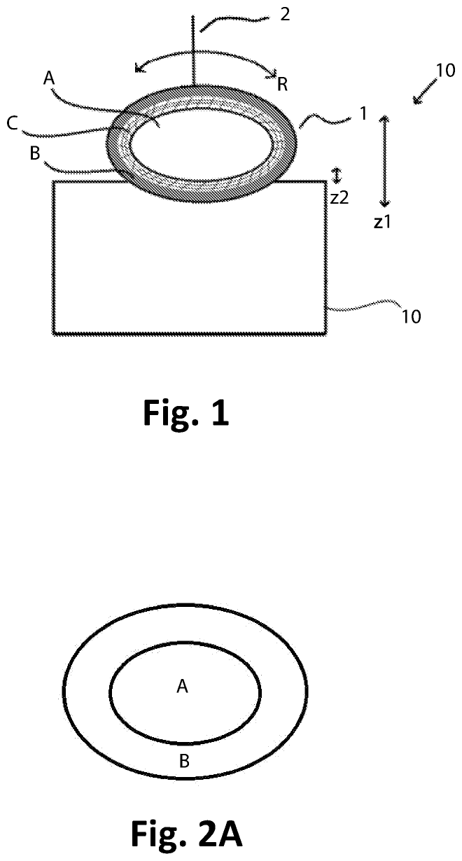

Turning now to the description of the aforementioned figures, and in particular initially FIG. 1, it can be seen that a system 100 for carrying out a process according to the disclosure is shown, comprising a tank or bath 10, at least one frame 2 to which lenses 1 are attached, which are immersed at least partially in the dye bath 10 along an axis z1.

A second axis z2, parallel to said axis z1, is also described in the figure.

Each frame 2 bearing lenses 1 will have a first vertical stroke, in both directions, along the axis z1 (step of immersion of the lenses 1 in the bath 10) and a second vertical stroke along the axis z2 (the function of which will be described in more detail below), in which the long stroke z1 is greater than the long stroke z2.

Said frame 2 is also provided with a rotary movement, in both directions of rotation, according to the arrow R in FIG. 1, with the axis of rotation according to the arrow R which may be at the optical or geometric centre of the lenses 1, but may also not be there, but rather in another point of the lenses 1, depending on the desired shape and tinting and/or shading.

The geometric centre is taken into account in the case of circular lenses.

As is well known, there are lenses in which the geometric centre and the optical centre do not coincide (off-centre lenses).

For the machine described according to the embodiment illustrated, it was chosen to rotate the lenses about the geometric centre.

The shading shape can still be freely positioned and, for example, a circle can be made off-centre with respect to the geometric centre or centre of rotation.

It is the combined movement along the vertical axis z2 and the direction of rotation R that will determine the shape of tinting/shading of the lens.

As can be seen in the figure, both the axis z1 and the axis z2 are perpendicular to the free surface of the dye bath 10, independent of each other.

The rotary axis r, on the other hand, is perpendicular to the axes z1 and z2 and thus parallel to the free surface of the bath.

Depending on the desired shape, the rotational movement along the direction of rotation R can be according to a predetermined arc of a circle, and occur in either direction of the arrow.

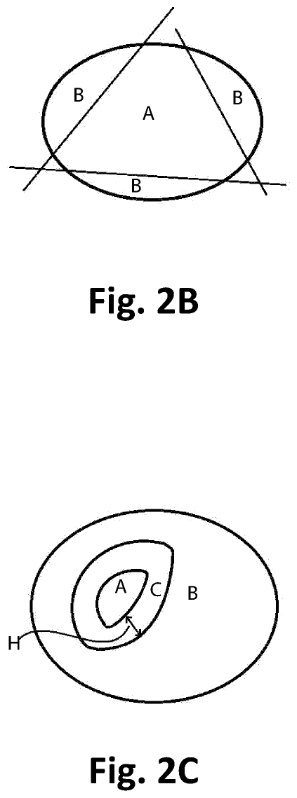

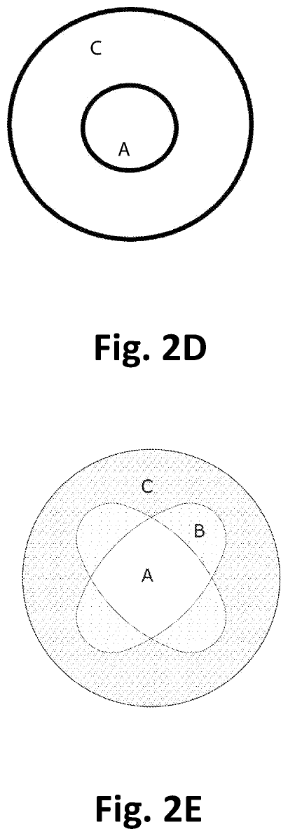

Looking now in detail at FIGS. 2A-2E, some of the shapes that can be obtained with the solution according to the disclosure are illustrated, and in particular:

FIG. 2A shows a lens tinted according to a closed shape in concentric circles, having a first zone of colour A and a second zone of colour B, wherein A and B are different colours and, in particular, A is the original colour of the lens 1 and B is the colour of the bath 10, and wherein the colour change is clear: the present shape is obtained by partially immersing the lens according to the axis z1, and rotating it in the direction R in the bath containing at least one dye (the immersed part is tinted according to colour B, wherein said colour B comes from the superposition of the colours of said at least one dye contained in the bath 10 and said colour A, wherein colour A may also be transparent);

FIG. 2B shows a lens 1 tinted according to an open triangular geometric shape: this shape is obtained by three partial immersions along z1, wherein between each immersion the lens is rotated in a range between 0° and 180°, in particular 120° about the rotary axis r;

FIG. 2C shows a lens 1 tinted and shaded according to a closed shape, having a first zone of colour A, a second zone of colour B and a third zone shaded according to a gradient C of transition from colour A to colour B, wherein said third shaded zone has a pre-set amplitude H and a pre-set course: this shape is obtained by partial immersion of the lens along z1 and a combined movement along the axes z2 and r;

FIG. 2D shows a lens 1 shaded according to a closed shape with concentric circles, having a first zone of colour A and a zone shaded according to a gradient C;

FIG. 2E shows a lens tinted and shaded according to the shape illustrated: this shape is obtained by means of two tinting cycles as said shape contains four concave zones.

However, it can be decomposed into 2 convex shapes: each of the two tinted and shaded parts is obtained by means of a tinting cycle in which the immersion movement along z1 is combined with the rotational movement about the rotary axis r and the vertical oscillation movement along the axis z2.

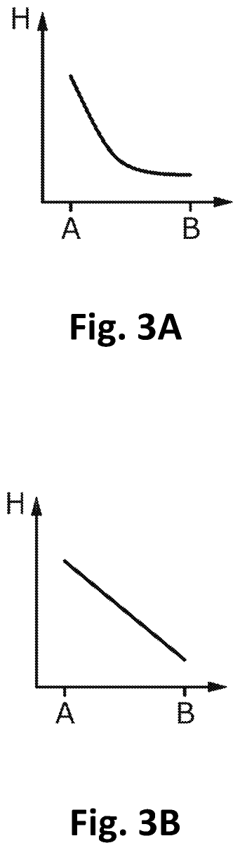

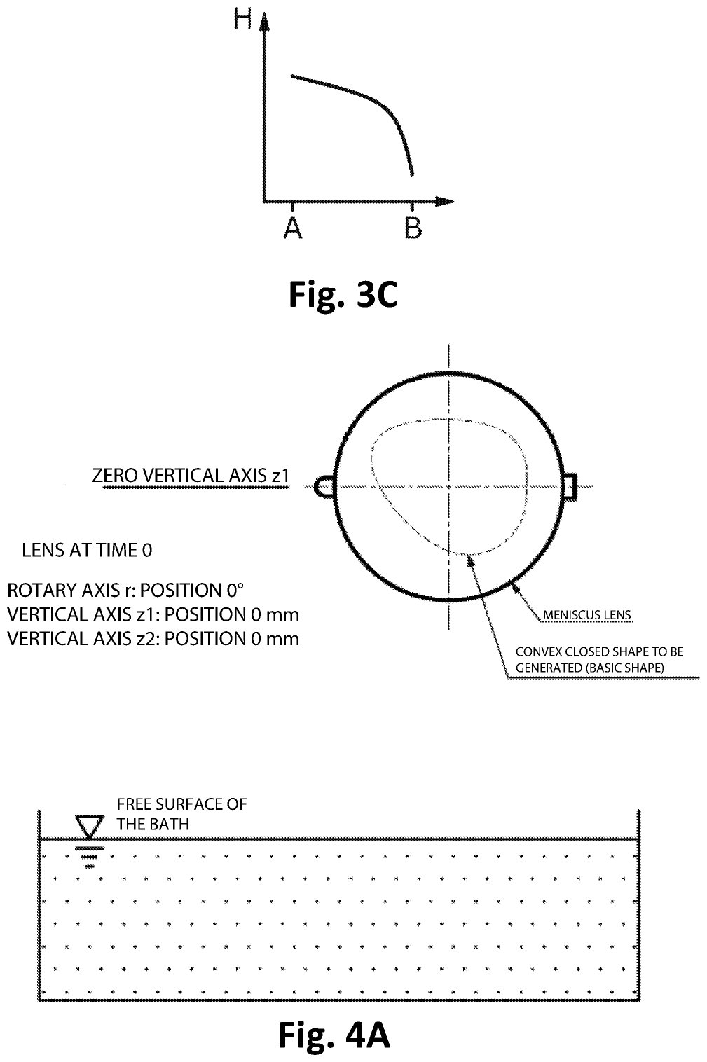

From the graphs in FIGS. 3A-3C, however, it can be seen that the colour change from A to B, across the transition gradient C, may be of different types. During immersion, the lens may therefore rotate about a point, which is not necessarily coincident with the geometric centre of the lens.

As mentioned above, the partial immersion of the lens in the bath occurs along the axis z1.

This immersion movement along z1 allows the lens 1 to be tinted, while the combined movement along the axes z1, z2 and along the direction of rotation R allows particular, predefined shape to be generated.

Colour A is the colour of the lens before immersion in the bath 10, and may also be transparent.

Colour B is the colour with which each point of the lens is tinted when immersed in said bath 10. Thus, colour B is the colour provided by the combination of the colours of said at least one dye contained in the bath and colour A.

The tinting of the lens 1 occurs on both surfaces of the lenses 1, unless the surface that is not to be tinted is masked.

In the device 100 performing the process for obtaining lenses 1 according to the disclosure, the axes R, z1 and z2 are controlled by a CNC-type handling system, which is able to interpolate the rotation R and linear movements according to the axes z1 and z2 to generate the established shape, and possibly create a colour shading effect.

For example, looking at FIG. 2A, a lens of colour A is processed to have colour B in certain zones.

The shape of the lens tinting and/or shading can be closed or open, in a defined position relative to the geometric centre of the lens.

This shape is obtained as a superposition of the tangent at each point of the shape, thus generating a shape with concave curved sections.

As shown in FIG. 2E, shapes having concave curved sections can be obtained by means of several tinting cycles, breaking down the shape having one or more concave curved sections into several shapes, all of which are convex. The superposition of these convex shapes by several tinting cycles thus generates the desired concave shape.

Alternatively, it would be possible to obtain tinted and/or shaded lenses according to shapes with concave curved lines, after masking the lens surface corresponding to the surface of the shape that is not to be tinted.

Once the lenses have been arranged on a frame, and the machine has been set up with the desired tinting and/or shading characteristics, the frames are placed on the machine basket. Said basket is motorised according to the axis z1.

The lens can then move on to the first tinting cycle: it is then immersed in a bath containing at least one solvent and at least one dye, which may also contain auxiliary chemical products.

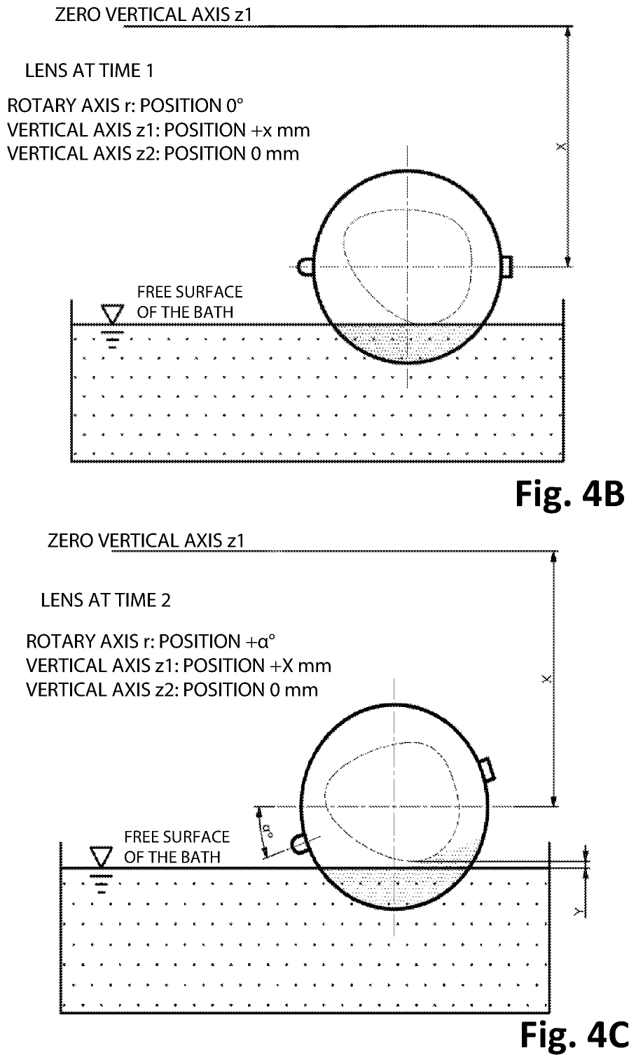

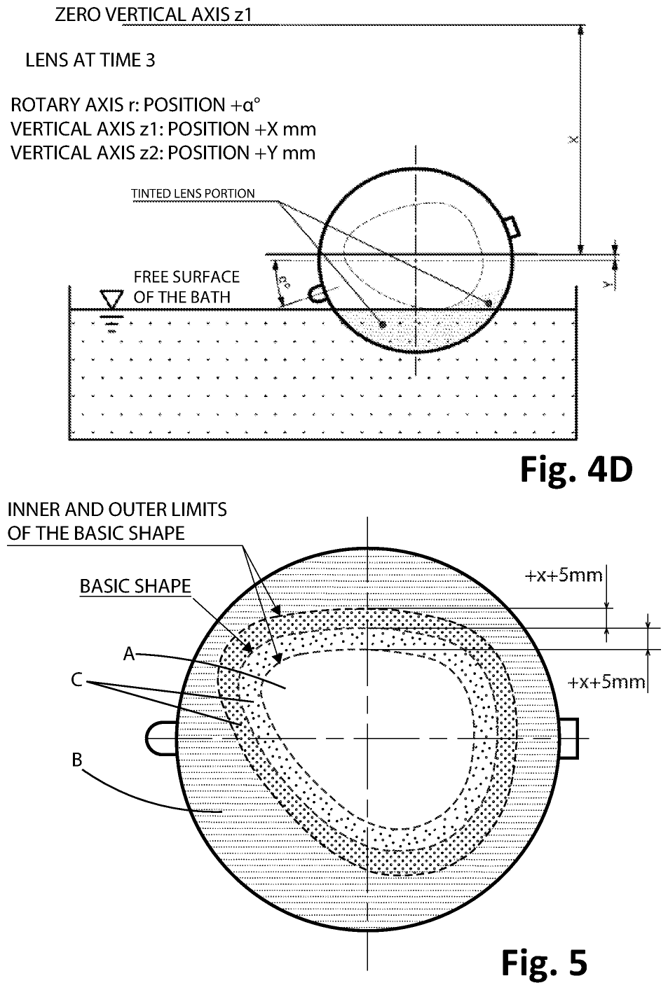

Referring now in particular to FIGS. 1, 4 and 5, a description of a preferred form of operation of the device 100 according to the disclosure, and its operating logic, will be provided.

This description is in no way to be considered as limiting the solution according to the disclosure.

As mentioned, the device 100 according to the disclosure comprises a tinting tank 10 with a liquid bath composed of at least one solvent and one or more pigments. Such a bath 10 may be a solution or a mixture.

Frames 2, on which lenses 1 are fixed vertically, are also provided.

As already described, there are 3 axes, controlled by the CNC, and in particular:

Rotary axis r, parallel to the free surface of the liquid in the tinting bath 10, or direction of rotation R, about which the frames 2 are rotated. This rotation is managed by the CNC.

Vertical axis z1: brings the frames 2 into the working position and can, if necessary, perform the movements of the frames 2 handled by the CNC. These movements are generically referred to as vertical and their amplitude defines the amplitude of the shading.

Vertical axis z2: the movements along said axis z2 allow for further movements of the frames 2, set by the CNC controller. The interpolation between the movement of this axis z2 and those along the direction of rotation R generates any shape, closed (and convex) or open, which can be generated by the CNC by interpolating the two movements.

An embodiment of the logic for tinting a lens with the generation of a basic shape without a colour shading zone will now be described.

The axis z1 is only used to bring the lenses 1 into the initial position. In this case, it is the interpolated movements along the axis z2 and the direction of rotation R that generate the shape.

If, on the other hand, a lens 1 is to be generated with a basic shape and a shaded zone, e.g. 10 mm, 5 mm of which outside and 5 mm inside the basic shape, the shaded zone is generated by the oscillation of the axis z1, while the combination of movements along the axis z2 and along the direction of rotation R generates the basic shape.

In particular, the axis z1 oscillates by 10 mm, moving from the position+X+5 mm to the position+X−5 mm (see FIG. 5).

At the end of the tinting cycle, the lenses thus obtained undergo washing, to remove said at least one excess dye, and any residual contaminants, and further lens finishing processes known in the state of the art.

The dye bath is preferably an aqueous bath.

The temperature of the dye bath depends on the dye compounds used and the lens material.

In a preferred embodiment according to the present disclosure, the dye bath contains one or more dyes.

The lens according to the disclosure can be made of, for example (the list of materials not being exhaustive, and thus not being able to be used to unduly limit the present disclosure), any material that can be tinted, for example glass, polyamide, polycarbonate, CR39, NXT. As dyes, one or more dyes according to the primary colours blue, red and yellow are preferably used. Secondary colours can also be used as dyes.

The lens according to the disclosure can be either polar or non-polar. In the polar embodiment, the lens is functionalised and, for example, comprises a polarising layer or film.

Numerous functional and/or aesthetic treatments can be applied to the lens, by way of non-limiting example, photochromic, anti-reflective, anti-fog or anti-misting, hydrophilic, hydrophobic and/or anti-stain, oleophobic, scratchproof, anti-static, lacquering and other treatments known in the state of the art. Said treatments can be applied to the outer surface and/or the inner surface of the lens.

In addition, UV/laser print decorations, pad printing, mould decorations can be applied to the lens, and/or two-dimensional elements visible to the viewer from the outside can be inserted in the lens, such as two-dimensional inserts for decorative and/or functional purposes containing electronics (e.g. RFID tags).

The present disclosure has been described by way of a non-limiting illustrative example according to preferred embodiments thereof, however, it is understood that variations and/or modifications may be introduced by those skilled in the art, without thereby departing from the relative scope of protection defined in the attached claims.

1. A lens tinted and/or shaded according to a particular and predefined shape having at least a first colour zone (A) and at least a second colour zone (B) and/or at least a third shaded zone according to a gradient (C) of transition from colour (A) to colour (B), said at least a second colour zone (B) and/or said at least a third shaded zone according to a gradient (C) being obtainable by subjecting a lens of colour (A) to a process including the following steps:
a. positioning a plurality of lenses on at least one frame, arranging said at least one frame above a colouring tank or bath, said at least one frame being vertically movable along a first vertical axis z1 and a second vertical axis z2, the stroke of z1 being greater than the stroke of z2, said at least one frame also being rotatable about an axis of rotation (R), perpendicular to said axes z1 and z2, and parallel to the free surface of the bath;
the shape on the lens being obtained by a combination of movement according to the axis z1 and/or according to the axis z2 and/or according to the rotary axis (r) or the rotation direction (R).

2. The lens according to claim 1, wherein said bath further comprises auxiliary chemical products selected from dispersing agents and/or foaming agents.

3. The lens according to claim 1, wherein the temperature of said dye bath is comprised between 60° C. and 120° C.

4. The lens according to claim 1, wherein said at least one dye is of a colour selected from the primary colours blue, red and yellow.

5. The lens according to claim 1, wherein said lens is subjected to two or more tinting cycles.

6. The lens according to claim 1, wherein a masking step is provided.

7. The lens according to claim 1, wherein said particular and predefined shape is an open or closed shape.

8. The lens according to claim 1, wherein said particular and predefined tinted shape contains one or more convex curved sections and/or one or more straight sections.

9. The lens according to claim 1, wherein the lens characterized in that it is made of glass, polyamide, polycarbonate, CR39, NXT, or mixtures thereof.

10. Eyeglasses containing at least one lens according to claim 1.

11. A process for obtaining a lens according to claim 1.
